(19) United States
(12) Patent Application Publication
(10) Pub. No.: US 2010/0250564 A1
(43) Pub. Date: Sep. 30, 2010

(54) TRANSLATING A COMPREHENSION INTO CODE FOR EXECUTION ON A SINGLE INSTRUCTION, MULTIPLE DATA (SIMD) EXECUTION

(75) Inventors: Amit Agarwal, Bellevue, WA (US); Igor Ostrovsky, Bellevue, WA (US); John Duffy, Renton, WA (US); Vivan Sewelson, Vashon, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/413,780

(22) Filed: Mar. 30, 2009

(51) Int. Cl. G06F 17/30

(52) U.S. Cl. 707/756; 707/E17.044; 707/E17.07

(57) ABSTRACT

A method of translating a comprehension into executable code for execution on a SIMD (Single Instruction, Multiple Data stream) execution unit, includes receiving a user specified comprehension. The comprehension is compiled into a first set of executable code. An intermediate representation is generated based on the first set of executable code. The intermediate representation is translated into a second set of executable code that is configured to be executed by a SIMD execution unit.

### BACKGROUND

Graphical processing units (GPUs) were originally developed for efficient processing of graphics and video. In recent years, there has been a surge in the interest of using GPUs for general-purpose computing. A reason behind this is the change in CPU trends in recent years. The exponential growth in the number of transistors per chip no longer translates into an exponential growth of the processor speed. Since the speed of single-core chips is no longer increasing at a rapid pace, users are exploring other avenues for increasing the performance of their applications. One significant obstacle slowing down the adoption of general-purpose GPU computing is the difficulty of writing programs for GPUs.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

One embodiment takes advantage of data comprehensions, such as language-integrated queries, to simplify GPU programming for mainstream developers. Language-integrated queries are used in the industry to provide abstractions over various kinds of sequence-based operations.

In one embodiment, a user specified comprehension is compiled into a first set of executable code. An intermediate representation is generated based on the first set of executable code. The intermediate representation is translated into a second set of executable code that is configured to be executed by a SIMD execution unit.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated, as they become better understood by reference to the following detailed description. The elements of the drawings are not necessarily to scale relative to each other. Like reference numerals designate corresponding similar parts.

FIG. 1 is a diagram illustrating a computing system suitable for performing execution of queries on a SIMD execution unit according to one embodiment.

FIG. 2 is a diagrammatic view of a query execution application for operation on the computer system illustrated in FIG. 1 according to one embodiment.

FIG. 3 is a flow diagram illustrating a method of translating a comprehension into executable code for execution on a SIMD execution unit according to one embodiment.

FIG. 4 is a diagram illustrating a data structure generated by the method shown in FIG. 3 for an example query according to one embodiment.

FIG. 5 is a diagram illustrating an execution graph generated by the method shown in FIG. 3 for an example query according to one embodiment.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

One embodiment provides a query execution application for performing execution of queries on a SIMD (Single Instruction, Multiple Data stream) execution unit, such as a graphical processing unit (GPU), but the technologies and techniques described herein also serve other purposes in addition to these. In one implementation, one or more of the techniques described herein can be implemented as features within a framework program such as Microsoft® .NET Framework, or within any other type of program or service. A GPU is one example of a SIMD execution unit. It will be understood that the techniques described herein are not limited to GPUs, but are also applicable to other SIMD execution units. A SIMD execution unit according to one embodiment is a substantially parallel unit that exhibits SIMD execution behavior, uses mostly or entirely a disjoint memory system, and uses an instruction set architecture (ISA) with specialized vector capabilities.

As mentioned above in the Background section, since the speed of single-core chips is no longer increasing at a rapid pace, users are exploring other avenues for increasing the performance of their applications. GPUs present one solution that works well for an interesting class of problems, namely large data-parallel numeric-intensive computations. The architecture of modern GPUs is fairly different from the architecture of modern CPUs. GPUs typically consists of many simple, in-order cores optimized for arithmetic computation, while CPUs consist of a small number of more sophisticated out-of-order cores optimized for a wide variety of uses.

One obstacle slowing down the adoption of general-purpose GPU computing is the difficulty of writing programs for GPUs. One embodiment takes advantage of comprehensions, such as language-integrated queries, to simplify GPU programming for mainstream developers. Language-integrated queries are used in the industry to provide abstractions over various kinds of sequence-based operations. As an example, Microsoft® supports the LINQ (Language Integrated Query) programming model, which is a set of patterns and technologies that allow the user to describe a query that will execute on a variety of different execution engines.

One embodiment provides developers with the ability to program a GPU using intuitive language integrated queries, without worrying about or being involved with the details of GPU hardware, communication between the CPU and the GPU, and other complex details. In one embodiment, a developer describes the query using a convenient query syntax that consists of a variety of query operators such as projections, filters, aggregations, and so forth. The operators themselves may contain one or more expressions or expression parameters. For example, a “Where” operator will contain a filter expression that will determine which elements should pass the filter. An expression according to one embodiment is a combination of letters, numbers, and symbols used to represent a computation that produces a value. The operators together with the expressions provide a complete description of the query.

One embodiment provides a query execution application or query engine that executes data-parallel queries on a GPU. In one embodiment, a compiler compiles the query into code that constructs an operator tree and associated expression trees. Operator trees and expression trees according to one embodiment are non-executable data structures in which each part of the corresponding operator or expression is represented by a node in a tree-shaped structure. Operator trees and expression trees according to one embodiment represent language-level code in the form of data. At runtime, the code is executed by a runtime environment and the operator tree and associated expression trees are constructed. The trees are combined and translated into an execution graph. The runtime environment compiles the execution graph into code that can execute on a GPU, and then executes the code on the GPU. The query engine according to one embodiment is configured to decide whether to execute a particular query on a CPU or on a GPU, using various heuristics to predict the performance in both cases. In one embodiment, the query engine is configured to decide to execute parts of the query on a CPU, and parts of the query on a GPU, to achieve improved performance. The GPU and the CPU can compute parts of the work concurrently or non-concurrently. In one embodiment, the query engine is configured to translate a first portion of a query into executable code that is configured to be executed by a GPU, and translate a second portion of the query into executable code that is configured to be executed by a CPU.

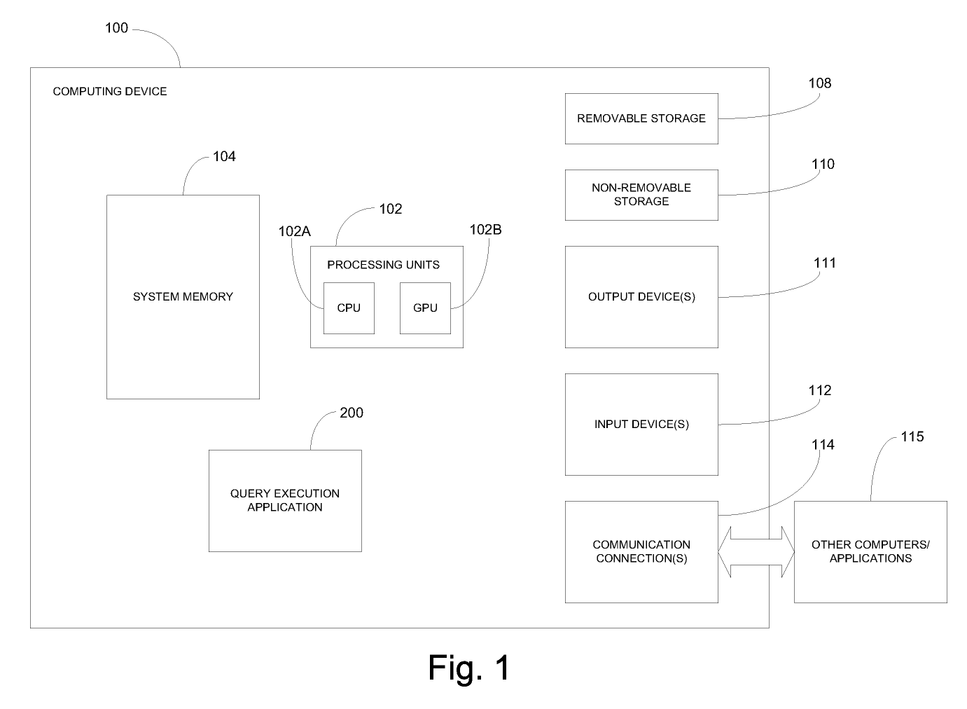

FIG. 1 is a diagram illustrating a computing device 100 suitable for performing execution of queries on a SIMD execution unit according to one embodiment. In the illustrated embodiment, the computing system or computing device 100 includes a plurality of processing units 102 and system memory 104. In one embodiment, processing units 102 include at least one central processing unit (CPU) 102A and at least one GPU 102B. In another embodiment, rather than or in addition to including a GPU 102B, processing units 102 may include one or more other SIMD execution units. Depending on the exact configuration and type of computing device, memory 104 may be volatile (such as RAM), non-volatile (such as ROM, flash memory, etc.), or some combination of the two.

Computing device 100 may also have additional features/functionality. For example, computing device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any suitable method or technology for storage of information such as computer readable instructions, data structures, program modules or other data. Memory 104, removable storage 108 and non-removable storage 110 are all examples of computer storage media (e.g., computer-readable storage media storing computer-executable instructions for performing a method). Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by computing device 100. Any such computer storage media may be part of computing device 100.

Computing device 100 includes one or more communication connections 114 that allow computing device 100 to communicate with other computers/applications 115. Computing device 100 may also include input device(s) 112, such as keyboard, pointing device (e.g., mouse), pen, voice input device, touch input device, etc. Computing device 100 may also include output device(s) 111, such as a display, speakers, printer, etc.

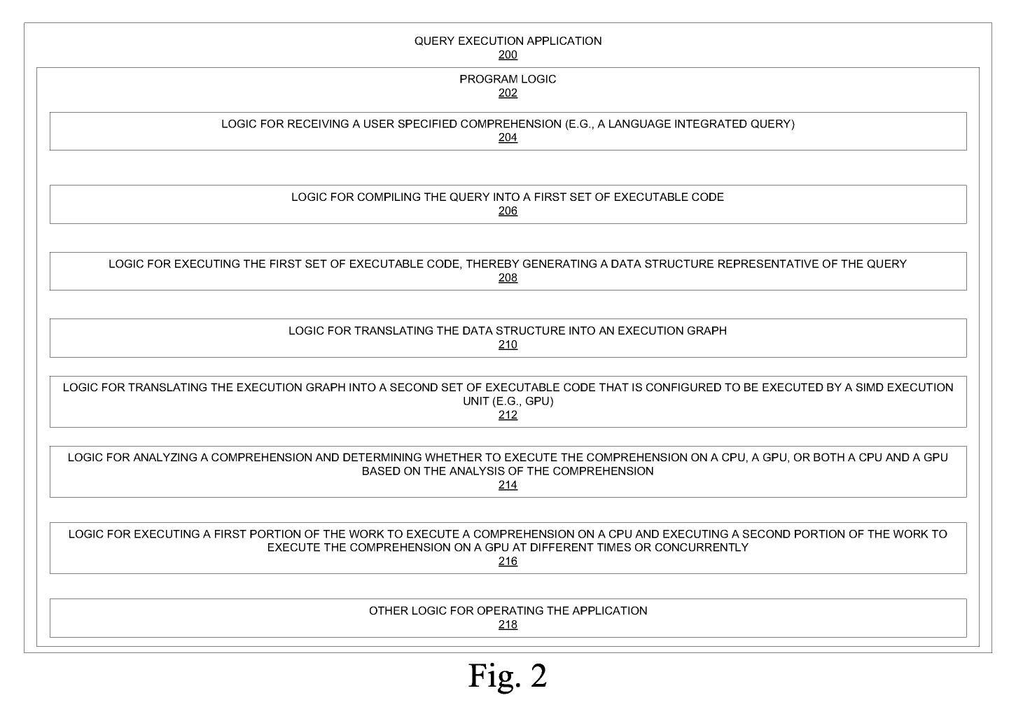

In one embodiment, computing device 100 includes a query execution application (query engine) 200 for performing execution of comprehensions, such as language integrated queries, on a SIMD execution unit, such as a GPU. Query execution application 200 is described in further detail below with reference to FIG. 2.

FIG. 2 is a diagrammatic view of one embodiment of a query execution application 200 for operation on the computing device 100 illustrated in FIG. 1 according to one embodiment. Application 200 is one of the application programs that reside on computing device 100. However, application 200 can alternatively or additionally be embodied as computer-executable instructions on one or more computers and/or in different variations than illustrated in FIG. 1. Alternatively or additionally, one or more parts of application 200 can be part of system memory 104, on other computers and/or applications 115, or other such suitable variations as would occur to one in the computer software art.

Query execution application 200 includes program logic 202, which is responsible for carrying out some or all of the techniques described herein. Program logic 202 includes logic 204 for receiving a user specified comprehension (e.g., a language integrated query); logic 206 for compiling the query into a first set of executable code; logic 208 for executing the first set of executable code, thereby generating a data structure representative of the query; logic 210 for translating the data structure into an execution graph; logic 212 for translating the execution graph into a second set of executable code that is configured to be executed by a SIMD execution unit (e.g., a GPU); logic 214 for analyzing a comprehension (e.g., a query) and determining whether to execute the comprehension on a CPU, a GPU, or both a CPU and a GPU based on the analysis of the comprehension; logic 216 for executing a first portion of the work to execute a comprehension on a CPU and executing a second portion of the work to execute the comprehension on a GPU at different times or concurrently; and other logic 218 for operating the application.

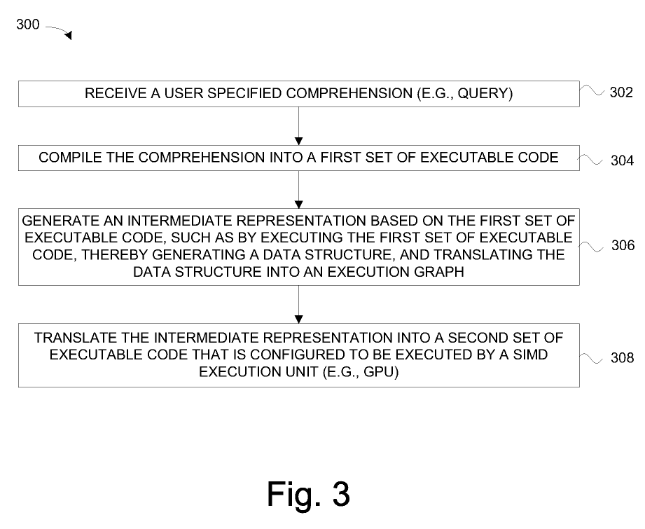

Turning now to FIGS. 3-5, techniques for implementing one or more embodiments of query execution application 200 are described in further detail. In some implementations, the techniques illustrated in FIGS. 3-5 are at least partially implemented in the operating logic of computing device 100.

FIG. 3 is a flow diagram illustrating a method 300 of translating a comprehension (e.g., a query) into executable code for execution on a SIMD execution unit (e.g., a GPU) according to one embodiment. At 302 in method 300, a user specified comprehension (e.g., query) is received. In one embodiment, the comprehension received at 302 is a language integrated query that comprises at least one operator and at least one expression parameter for the at least one operator. In one embodiment, the query is specified in a high-level programming language (e.g., C#). At 304, the comprehension is compiled into a first set of executable code. At 306, an intermediate representation is generated based on the first set of executable code, such as by executing the first set of executable code, thereby generating a data structure, and translating the data structure into an execution graph. In one embodiment, the data structure generated at 306 is representative of the query and comprises at least one operator tree and at least one associated expression tree. In one embodiment, the execution graph generated at 306 comprises a directed acyclic graph (DAG).

At 308, the intermediate representation is translated into a second set of executable code that is configured to be executed by a SIMD execution unit (e.g., GPU).

Method 300 according to one embodiment will now be described in further detail with reference to an example query. As mentioned above, at 302 in method 300, a user specified comprehension (e.g., query) is received. In one embodiment, the developer specifies their query in a high-level programming language, such as C#. The following Pseudo Code Example I provides an example of a language integrated query in C# that computes “x*(x−2)+7” for each element in the array, arr, and then sums up all of the results:

PSEUDO CODE EXAMPLE I

```
int result = arr.OnGpu( )
    .Select(x => x*(x−2) + 7)
    .Sum( );
```

The query received at 302 in method 300 is compiled into a first set of executable code at 304. In one embodiment, when the compiler compiles the code in Example I into a low-level machine representation at 304, the compiler will bind the query operators to appropriate methods, and replace the expression “x=>x*(x−2)+7” with code that will construct a representation of the computation at runtime. The translated code according to one embodiment will look like that given in the following Pseudo Code Example II:

PSEUDO CODE EXAMPLE II

```
int result =
  GPU.Sum(
    GPU.Select(
      new AddExpression(
        new MultiplyExpression(
          new ConstantExpression(“x”),
          ... // some code not shown for brevity
      GPU.OnGpu(arr)));
```

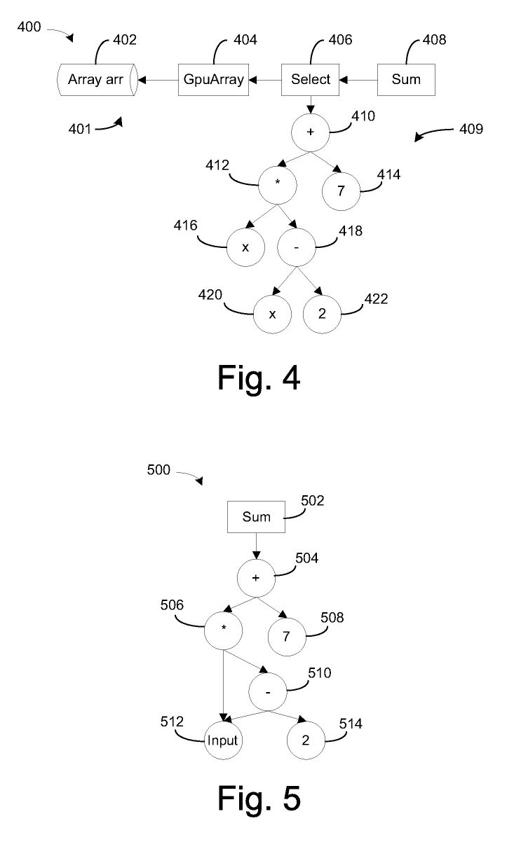

In one embodiment, when the code in Example II executes at runtime (at 306 in method 300), it will construct a data structure that represents a query operator tree, and additional linked data structures (expression trees) that represent the expressions inside different operators. FIG. 4 is a diagram illustrating a data structure 400 generated at 306 in method 300 for the example query given in Pseudo Code Example I according to one embodiment. As shown in FIG. 4, data structure 400 includes an operator tree 401 and an expression tree 409. Operator tree 401 includes operators 404-408, and expression tree 409 includes expression parameters 410-422. Block 402 corresponds to the array, arr, in Pseudo Code Example I, and the three operators 404-408 correspond to the OnGpuo, Selecto, and Sumo operators, respectively, in Example I. The operator tree 409 is associated with the select operator 406, and corresponds to the expression “x*(x−2)+7” in Example I.

The data structure 400 generated at 306 in method 300 is also translated into an execution graph at 306. FIG. 5 is a diagram illustrating an execution graph 500 generated at 306 in method 300 for the example query given in Pseudo Code Example I according to one embodiment. As shown in FIG. 5, execution graph 500 includes nodes 502-514. Execution graph 500 is similar to the expression tree 409 shown in FIG. 4, but the two expression parameters 416 and 420 (i.e., “x”) have been replaced in FIG. 5 by a single input node 512. Sum node 502 corresponds to the Sum operator 408 in FIG. 4.

The execution graph 500 generated at 306 in method 300 is translated at 308 into code that can execute on one or more SIMD execution units (e.g., GPUs). In one embodiment, the inputs are copied on the GPU, the query is run on the GPU, and the answers are copied back.

In one embodiment, query execution application 200 is configured to inspect a particular query and decide to execute it on a CPU rather than a GPU (e.g., if the particular query has a form that is not suitable for execution on a GPU). Also, the query execution application 200 is configured in one embodiment to decide to execute parts of the query on a GPU, and parts of the query on a CPU, in order to exploit the strengths of both platforms. The application 200 is also configured in one embodiment to use the GPU and the CPU concurrently to execute different parts of the query, in order to improve the performance even further. In another embodiment, execution is performed in batches. For example, in one form of this embodiment, application 200 chunks the input into a certain size, and for each chunk, processes the chunk on the GPU, copies the results to the CPU, and sends the next chunk to run asynchronously on the GPU while the results from the previous chunk are being processed concurrently on the CPU. In this manner, chunks can be pipelined between the GPU and CPU.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of translating a comprehension into executable code for execution on a SIMD (Single Instruction, Multiple Data stream) execution unit, comprising:
receiving a user specified comprehension;
compiling the comprehension into a first set of executable code;
generating an intermediate representation based on the first set of executable code; and
translating the intermediate representation into a second set of executable code that is configured to be executed by a SIMD execution unit.

2. The method of claim 1, wherein generating an intermediate representation comprises:
executing the first set of executable code, thereby generating a data structure; and
translating the data structure into an execution graph.

3. The method of claim 1, wherein the comprehension is a language integrated query.

4. The method of claim 1, wherein the comprehension comprises at least one operator and at least one expression parameter for the at least one operator.

5. The method of claim 2, wherein the generated data structure is representative of the comprehension.

6. The method of claim 2, wherein the generated data structure comprises at least one operator tree and at least one associated expression tree.

7. The method of claim 2, wherein the execution graph comprises a directed acyclic graph (DAG).

8. The method of claim 1, wherein the comprehension is specified in a high-level programming language.

9. The method of claim 1, wherein the SIMD execution unit is a graphical processing unit (GPU), and wherein the method further comprises:
analyzing the comprehension; and
determining whether to execute the comprehension on a CPU, a GPU, or both the CPU and the GPU based on the analysis of the comprehension.

10. The method of claim 9, and further comprising:
executing a first portion of the comprehension on a CPU; and
executing a second portion of the comprehension on a GPU.

11. The method of claim 10, wherein the first and second portions of the comprehension are executed concurrently.

12. A computer-readable storage medium storing computer-executable instructions for performing a method, comprising:
receiving a user specified language integrated query comprising at least one operator and at least one expression parameter for the at least one operator;
compiling the query into a first set of executable code;
executing the first set of executable code, thereby generating a data structure;
translating the data structure into an execution graph; and
translating the execution graph into a second set of executable code that is configured to be executed by a GPU.

13. The computer-readable storage medium of claim 12, wherein the generated data structure is representative of the query.

14. The computer-readable storage medium of claim 12, wherein the generated data structure comprises at least one operator tree and at least one associated expression tree.

15. The computer-readable storage medium of claim 12, wherein the execution graph comprises a directed acyclic graph (DAG).

16. The computer-readable storage medium of claim 12, wherein the query is specified in a high-level programming language.

17. The computer-readable storage medium of claim 16, wherein the high-level programming language is C#.

18. A method of executing a query, comprising:
receiving a user specified language integrated query comprising at least one operator and at least one expression parameter for the at least one operator;
compiling a first portion of the query into a first set of executable code;
executing the first set of executable code, thereby generating a data structure;
translating the data structure into an execution graph;
translating the execution graph into a second set of executable code that is configured to be executed by a GPU; and
translating a second portion of the query into a third set of executable code that is configured to be executed by a CPU.

19. The method of claim 18, wherein the generated data structure comprises at least one operator tree and at least one associated expression tree.

20. The method of claim 18, wherein the execution graph comprises a directed acyclic graph (DAG).
